(19) United States
(12) Patent Application Publication
(10) Pub. No.: US 2009/0073515 A1
(43) Pub. Date: Mar. 19, 2009

(54) IMAGE FORMING APPARATUS AND IMAGE FORMING METHOD

(76) Inventor: Hajime TAKACHI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/211,471

(22) Filed: Sep. 16, 2008

(30) Foreign Application Priority Data
Sep. 19, 2007 (JP) JP2007-242836

(51) Int. Cl. H04N 1/46

(52) U.S. Cl. 358/501

(57) ABSTRACT

When forming images in respective colors each being formed on each block obtained by dividing one circumference of a photoreceptor drum into n parts, there are provided an image forming section that has photoreceptor drums respectively for Y, M, C and BK colors which form respective color images, encoder that detects TRIG signal of any one photoreceptor drum, corrected index generating section that corrects reference index signals based on the TRIG signal and generates Y-IDX signals after correction for each image forming color and timing control section that compares the pulse number of Y-IDX signals with the pulse number of reference index signals, and adjusts output timing of image data for Y, M, C and BK colors based on the aforesaid comparison.

This application is based on Japanese Patent Application No. 2007-242836 filed on Sep. 19, 2007 in Japanese Patent Office, the entire content of which is hereby incorporated by reference.

### BACKGROUND OF THE INVENTION

The present invention relates to an image forming apparatus and an image forming method which can be favorably applied to a color printer, a color copying machine and a multifunctional machine having therein the functions of the color printer and the color copying machine, which are equipped with functions to write image data in large capacity memory for each image forming color, then, to read the image data from the aforesaid memory to be sent to a writing unit and to read the image data based on control signals.

Opportunities for a color printer, a color copying machine of a tandem type and their multifunctional machine to be used have been increased recently. In the image forming apparatus of this kind, when reproducing a R (red) color, a G (green) color and a B (blue) color of a color image, laser light sources are arranged to be in a line form, for example, LPH (Line Photo diode Head) unit that gives exposure collectively on a line unit basis is provided for each image forming color, toner images respectively for yellow (Y), magenta (M), cyan (C) and black (BK) are formed respectively on photoreceptor drums for respective image forming colors, thus, toner images for respective colors formed on photoreceptor drums for respective colors are superimposed on an intermediate transfer belt. The color toner images superimposed on the intermediate transfer belt are transferred onto a desired sheet to be ejected thereafter.

In the color image forming apparatus of a tandem type, if there is a fluctuation (unevenness) of rotating speed of a photoreceptor drum, disturbance is generated on printed images, which sometimes causes a color shift or line shift on the color image that is formed by superimposing a single color image by each color image forming unit.

Unexamined Japanese Patent Application Publication No. 7-225544 (Page 6, FIG. 1) discloses an image forming apparatus, relating to a color printer of a tandem type of this kind. In this image forming apparatus, photoreceptor drums for respective image forming colors are provided, and these plural photoreceptor drums are rotated by one driving source through a belt. On a shaft of each photoreceptor drum, an encoder (speed detecting device) is arranged, and a fluctuation of an amount of rotational movement estimated from rotating speed information obtained from each shaft is stored in advance, and recording timing is controlled by this amount of rotational movement. If the image forming apparatus is constructed in this way, it is possible to avoid a color shift when superimposing colors on the intermediate transfer body.

In the image forming apparatus disclosed by Unexamined Japanese Patent Application Publication No. 2000-089640 (Page 3, FIG. 1), a rotating operation detecting device, a signal filter and a writing timing control device are provided, and when uneven rotation of a photoreceptor drum is corrected, the rotating operation detecting device detects uneven rotation of the photoreceptor drum, and outputs uneven rotation detection signals to a signal filter. In the signal filter, low frequency component signals after removing repetitive components from uneven rotation detection signals are taken out and are outputted to a writing timing control device. The aforesaid low frequency component signals are caused by drum decentering. In the writing timing control device, an amount of rotational fluctuation is calculated from low frequency component signals, and image writing timing in the writing unit is determined based on this amount of rotational fluctuation. If the image forming apparatus is constructed in this way, it is possible to correct uneven rotation of the photoreceptor drum accurately and quickly.

In a color image forming apparatus of a tandem type, when correcting uneven rotation of a photoreceptor drum, a rotating speed fluctuation of the photoreceptor drum is detected, and reference signals (reference index signals) for image writing are corrected referring to an amount of correction that offsets the rotating speed fluctuation of the photoreceptor drum.

However, even in the case where image data for an image of the color are written on the photoreceptor drum based on reference signals for image writing after the correction that can offset the rotating speed fluctuation of the drum, it was confirmed that a position to start writing for each image forming color on the photoreceptor drum is fluctuated, depending on timing of start reading image data for an image of the color.

Owing to the foregoing, unevenness of rotating speed of the photoreceptor drum is calculated before the image forming, reference signals for image writing are corrected referring to an amount of correction, and the timing for writing images on the photoreceptor drum is fixed by using the corrected reference index signals. However, it has been confirmed that a position (line) to start writing for the forefront of an image of the color is shifted, if a phase of rotating speed unevenness in photoreceptor drum of each image forming color is different, even when the corrected reference index signals are generated on a cycle of cancelling rotating speed unevenness.

In this connection, in the image forming apparatus disclosed in Unexamined Japanese Patent Application Publication No. 7-225544 (Page 6, FIG. 1) and Unexamined Japanese Patent Application Publication No. 2000-089640 (Page 3, FIG. 1), there is a possibility that disturbances are generated on printed images or a color shift and line shift are generated on a color image in which single color images formed by respective color image forming units are superimposed, depending on the timing to start reading of image data, even when applying image writing reference signals which cancel rotating speed fluctuation of the photoreceptor drum, because the aforesaid image forming apparatuses are not those wherein a position to start writing for the forefront of images of the color formed on the photoreceptor drum is adjusted based on the image writing reference signals.

With the foregoing as a background, the present invention is one wherein the aforesaid problems have been solved, and an objective of the invention is to provide an image forming apparatus and an image forming method wherein a position to start writing for the forefront of images of respective colors can be adjusted referring to one signal obtained during a period for a photoreceptor drum to make one revolution, and shading unevenness of color images and image shift which are caused by rotating speed unevenness of low frequency of a photoreceptor drum can be eliminated.

### SUMMARY

For solving the aforesaid problems, an image forming apparatus relating to an embodiment of the invention is characterized to have an image forming device that has plural photoreceptor drums and forms a color image based on image data of each image forming color, a cycle detecting device that detects drum revolution signals generated while any one photoreceptor drum makes one revolution, a signal generating device that corrects reference signals for image writing under the reference of drum revolution signals detected by the cycle detecting device and generates reference signals for image writing after correction for each image forming color, and a control device that compares a pulse number of reference signals for image writing after correction generated by the signal generating device with a pulse number of the reference signals for image writing for each image forming color, and adjusts output timing of image data for each image forming color based on the results of the comparison.

In this image forming apparatus, when forming a color image based on image data for each image forming color, the control device compares the pulse number of reference signals for image writing after correction with the pulse number of reference signals for image writing, for each image forming color, and adjusts output timing of image data for each image forming color based on the results of the comparison.

Therefore, under the reference of revolution signals generated each time when any one of photoreceptor drums for respective image forming colors makes one revolution, a position (timing) to start writing for the forefront of each color image for photoreceptor drum for each image forming color can be adjusted.

The image forming method relating to an embodiment of the invention is characterized to have a step in which drum revolution signals generated by one revolution of any one photoreceptor drum are detected, a step in which reference signals for image writing are corrected for each image forming color based on the detected drum revolution signals, and reference signals for image writing after correction are generated, a step in which a pulse number of generated reference signals for image writing after correction is compared with a pulse number of reference signals for image writing for each image forming color and a step in which the output timing of image data for each image forming color is adjusted based on the results of the comparison, in the image forming method that forms a color image based on image data for each image forming color corresponding to plural photoreceptor drums.

### BRIEF DESCRIPTION OF THE DRAWINGS

FIG. 1 is a conceptual diagram showing a structural example of color printer 100 representing an embodiment relating to the invention.

FIG. 2 is a perspective view showing a structural example of image forming section 80.

FIG. 3 (A) and FIG. 3 (B) are diagrams showing respectively a circumference of photoreceptor drum 1Y or others and an example of fluctuation of rotating speed.

Each of FIG. 4 (A) and FIG. 4 (B) is an operation time chart showing an example of cycle correction of reference index signal.

Each of FIG. 5 (A) and FIG. 5 (B) is a diagram showing an example of cycle correction of reference index signals for cancelling rotating speed unevenness of photoreceptor drum 1Y and others.

FIG. 6 is a block diagram showing a structural example of writing control unit 15Y for Y color and of its peripheral portion.

FIGS. 7 (A)-7 (F) are time charts showing examples of operations for writing of image data Dy, Dm, Dc and Dk in large capacity memory.

FIGS. 8 (A)-8 (P) are time charts showing image data reading operations example I in color printer 100.

FIGS. 9 (A)-9 (P) are time charts showing image data reading operations example II in color printer 100.

### DETAILED DESCRIPTION OF THE PREFERRED EMBODIMENT

An image forming apparatus and an image forming method of the invention will be described as follows, referring to the drawings.

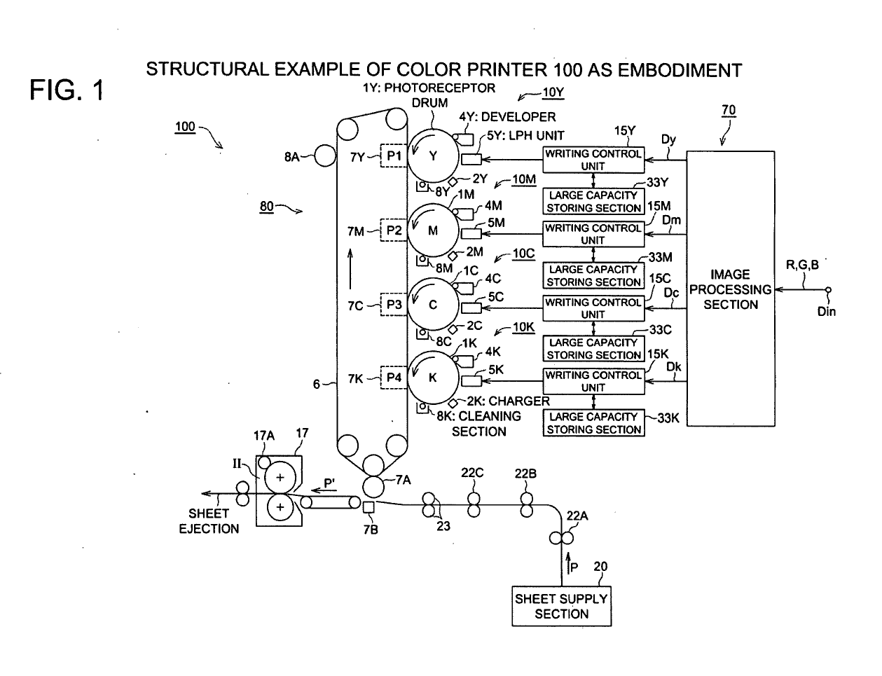

FIG. 1 is a conceptual diagram showing a structural example of color printer 100 representing an embodiment relating to the invention. Color printer 100 of a tandem type shown in FIG. 1 is of an example of the structure of an image forming apparatus wherein color images each being of a different color formed respectively on plural photoreceptor drums based on digital color image information are superimposed on an intermediate transfer belt. The color images are transferred onto a prescribed sheet and fixed. Color image information is supplied to the aforesaid printer 100 from an outer apparatus such as a personal computer.

The color printer 100 is composed of image processing section 70, a writing control unit, a large capacity storing section and an image forming section. The image processing section 70 receives color image information for reproducing R color, G color and B color from an outer apparatus, for example, and conducts color conversion processing for this color image information to output image data Dy, Dm, Dc and Dk which are respectively for Y, M, C and BK colors.

Writing control units 15Y, 15M, 15C and 15K respectively for Y, M, C and BK colors are connected to the image processing section 70, and in each of the writing control units 15Y, 15M, 15C and 15K, there are conducted controls for data writing on large capacity storing sections 33Y, 33M, 33C and 33K based on reference (pseudo) index signals (hereinafter referred to as reference index signals) constituting an example of reference signals for image writing and for reading of image data Dy, Dm, Dc and Dk to image forming section 80 from large capacity storing sections 33Y, 33M, 33C and 33K. In the image forming section 80, a circumference of a drum is divided into “n” parts for each of photoreceptor drums 1Y, 1M, 1C and 1K respectively for Y, M, C and BK colors, and reference index signals after correction are applied on each n-divided block, so that color images respectively for Y, M, C and BK colors may be formed.

For example, large capacity storing section 33Y is connected to writing control unit 15Y for Y color, and image data Dy for Y color outputted from the image processing section 70 are stored in the large capacity storing section 33Y based on the reference index signals. The writing control unit 15Y reads out image data Dy from the large capacity storing section 33Y based on writing reference (synchronous) signals for Y color after the reference index signals are corrected by drum revolution signals (hereinafter referred to as Y-IDX signals) and on vertical effective area signals on the reading side (hereinafter referred to as R-VVy signals), to output them to image forming section 80. The drum revolution signals mentioned here means signals obtained once per every measurement for one revolution of rotation of any one photoreceptor drum.

Large capacity storing section 33M is connected to writing control unit 15M for M color, and image data Dm for M color outputted from the image processing section 70 are stored in the large capacity storing section 33M based on the reference index signals. The writing control unit 15M reads out image data Dm from the large capacity storing section 33M based on writing reference (synchronous) signals for M color after the reference index signals are corrected by drum revolution signals (hereinafter referred to as M-IDX signals) and on vertical effective area signals on the reading side (hereinafter referred to as R-VVm signals), to output them to image forming section 80.

Large capacity storing section 33C is connected to writing control unit 15C for C color, and image data Dc for C color outputted from the image processing section 70 are stored in the large capacity storing section 33C based on the reference index signals. The writing control unit 15C reads out image data Dc from the large capacity storing section 33C based on writing reference (synchronous) signals for C color after the reference index signals are corrected by drum revolution signals (hereinafter referred to as C-IDX signals) and on vertical effective area signals on the reading side (hereinafter referred to as R-VVc signals), to output them to image forming section 80.

Large capacity storing section 33K is connected to writing control unit 15K for BK color, and image data Dk for BK color outputted from the image processing section 70 are stored in the large capacity storing section 33K based on the reference index signals. The writing control unit 15K reads out image data Dk from the large capacity storing section 33K based on writing reference (synchronous) signals for BK color after the reference index signals are corrected by drum revolution signals (hereinafter referred to as K-IDX signals) and on vertical effective area signals on the reading side (hereinafter referred to as R-VVk signals), to output them to image forming section 80.

The image forming section 80 is composed of image forming unit 10Y having photoreceptor drum 1Y for yellow (Y) color, image forming unit 10M having photoreceptor drum 1M for magenta (M) color, image forming unit 10C having photoreceptor drum 1C for cyan (C) color, image forming unit 10K having photoreceptor drum 1K for black (K) color and of endless-shaped intermediate transfer belt 6.

In the image forming section 80, an image forming processing is conducted for each of the photoreceptor drums 1Y, 1M, 1C and 1K, and toner images each having a different color formed respectively by photoreceptor drums 1Y, 1M, 1C and 1K for respective image forming colors are superimposed on intermediate transfer belt 6, so that a color image is formed.

In this example, image forming unit 10Y has therein charging unit 2Y, a line-shaped optical head (Line Photo diode Head; hereinafter referred to as LPH unit 5Y), developer 4 and cleaning device 8Y for an image forming body in addition to photoreceptor drum 1Y, and an image in yellow (Y) color is formed. Photoreceptor drum 1Y constitutes an example of an image carrier, and for example, it is provided to be close to the upper part on the right side of intermediate transfer belt 6 to be rotatable, so that a toner image in Y color is formed.

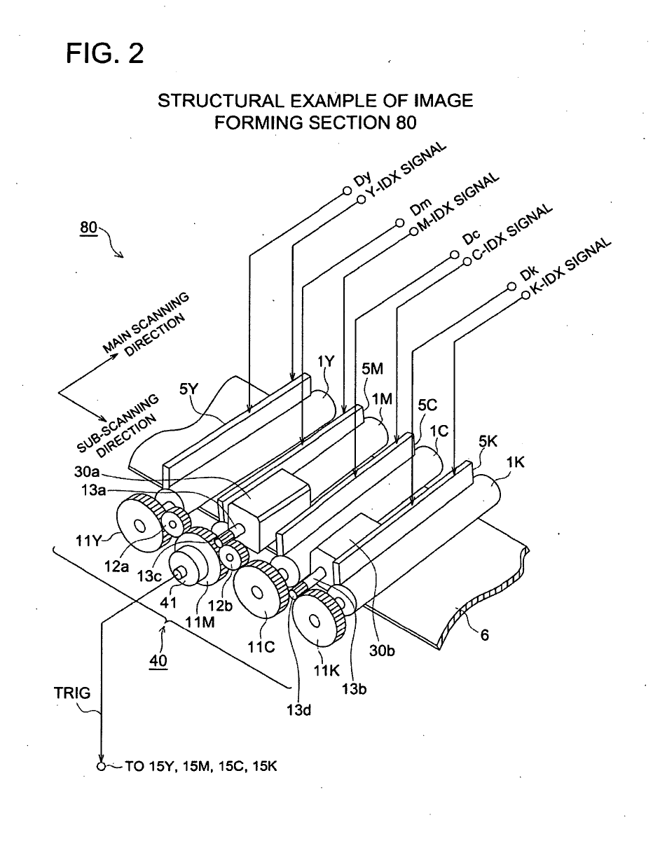

In this example, the photoreceptor drum 1Y is rotated counterclockwise by rotation transmitting mechanism 40 shown in FIG. 2. Charging unit 2Y is provided obliquely downward on the right side of the photoreceptor drum 1Y to charge the surface of the photoreceptor drum 1Y to the prescribed electric potential.

Almost right beside the photoreceptor drum 1Y, LPH unit 5Y is provided to face the photoreceptor drum 1Y, and the LPH unit 5Y applies a laser beam having prescribed intensity based on image data Dy for Y color on the photoreceptor drum 1Y which has been charged in advance through collective irradiation. The LPH unit 5Y on which an unillustrated LED head is arranged in a line form is used. For an image writing system, a scanning exposure system with an unillustrated polygon mirror may also be used in place of the LPH unit. On the photoreceptor drum 1Y, there is formed an electrostatic latent image for Y color.

Above the LPH unit 5Y, there is provided developer 4Y that operates to develop the electrostatic latent image for Y color formed on the photoreceptor drum 1Y. The developer 4Y has an unillustrated developing roller for Y color. Toner materials and carrier for Y color are loaded in the developer 4Y.

Inside the developing roller for Y color, a magnet is arranged, whereby, two-component developers obtained by stirring carrier and toner materials for Y color in developer 4Y are conveyed through rotation to the opposed region on the photoreceptor drum 1Y so that the electrostatic latent image is developed by the toner for Y color. This toner image of Y color formed on the photoreceptor drum 1Y is transferred onto intermediate transfer belt 6 through operations of primary transfer roller 7Y (primary transfer). On the lower part on the left side of the photoreceptor drum 1Y, there is provided cleaning device 8Y which removes the toner remaining on the photoreceptor drum 1Y after the preceding writing operation (cleaning).

In this example, image forming unit 10M is provided below the image forming unit 10Y. The image forming unit 10M has therein photoreceptor drum 1M, charging unit 2M, LPH unit 5M, developer 4M and cleaning device 8M for an image forming body, to form an image in a magenta (M) color.

Image forming unit 10C is provided below the image forming unit 10M. The image forming unit 10C has therein photoreceptor drum 1C, charging unit 2C, LPH unit 5C, developer 4C and cleaning device 5C for an image forming body, to form an image in a cyan (C) color.

Image forming unit 10K is provided below the image forming unit 10C. The image forming unit 10K has therein photoreceptor drum 1K, charging unit 2K, LPH unit 5K, developer 4K and cleaning device 8K for an image forming body, to form an image in a black (BK) color. An organic photoconductor (OPC) drum is used as each of photoreceptor drums 1Y, 1M, 1C and 1K.

In this connection, with respect to functions of each member of image forming units 10M-10K, descriptions of them will be omitted here because the description for 10Y can be used as descriptions for 10M-10K, by reading Y as M, C and K. On each of the aforesaid primary transfer rollers 7Y, 7M, 7C and 7K, there is impressed bias voltage for primary transfer that is opposite to that of the toner to be used in terms of polarity (positive polarity in the present embodiment).

Intermediate transfer belt 6 constitutes an example of an image carrier on which toner images transferred by primary transfer rollers 7Y, 7M, 7C and 7K are superimposed, and a color toner image (color image) is formed. In this case, under the condition that P1 represents a primary transfer point in primary transfer roller 7Y, P2 represents a primary transfer point in primary transfer roller 7M, P3 represents a primary transfer point in primary transfer roller 7C, P4 represents a primary transfer point in primary transfer roller 7K, images respectively on photoreceptor drums 1Y, 1M, 1C and 1K are transferred primarily onto intermediate transfer belt 6 in an order of Y color→M color→C color→BK color, in a tandem type.

In this type, the timing to write (expose) each of image data Dy, Dm, Dc and Dk respectively on each of photoreceptor drums 1Y, 1M, 1C and 1K is shifted by an amount equivalent to each of distances (P2−P1), (P3−P2) and (P4−P3) each being a distance from a primary transfer point for each image forming color to a primary transfer point for an adjoining color.

A color image formed on the intermediate transfer belt 6 through photoreceptor drums 1Y, 1M, 1C and 1K at the aforesaid timing is conveyed toward secondary transfer roller 7A, when the intermediate transfer belt 6 rotates clockwise. The secondary transfer roller 7A is positioned below the intermediate transfer belt 6, and secondary transfer unit 7B is provided below the secondary transfer roller 7A. The secondary transfer roller 7A together with secondary transfer unit 7B transfers a color toner image formed on intermediate transfer belt 6 collectively on sheet P (secondary transfer). The secondary transfer roller 7A is arranged so that toner materials remaining on the secondary transfer roller 7A after the preceding transfer may be removed (cleaning).

In this example, cleaning device 8A is provided on the upper part on the left side of the intermediate transfer belt 6, and it operates to remove a toner remaining on the intermediate transfer belt 6 after transfer operation. The cleaning device 8A has a neutralizing section (not shown) that neutralizes electric charges on the intermediate transfer belt 6 and a pad that removes a toner remaining on the intermediate transfer belt 6. A surface of the belt is cleaned by this cleaning device 8A, and intermediate transfer belt 6 neutralized by the neutralizing section enters the succeeding image forming cycle. owing to this, a color image can be formed on sheet P.

Color printer 100 is equipped with sheet supply section 20 and fixing device 17 in addition to image forming section 80. Below the aforesaid image forming unit 10K, there is provided sheet supply section 20 which is composed of plural sheet supply trays which are not illustrated. Sheets P in a prescribed size are loaded in each sheet tray.

On a sheet conveyance path from sheet supply section 20 to the lower part of image forming unit 10K, there are provided conveyance rollers 22A and 22C, loop roller 22B and registration roller 23. For example, the registration roller 23 holds prescribed sheet P fed out of the sheet supply section 20 at a position just immediately before secondary transfer roller 7A, and then, feeds it out to the secondary transfer roller 7A in synchronization with the image timing. The secondary transfer roller 7A transfers a color image carried by intermediate transfer belt 6 onto prescribed sheet P that is subjected to sheet conveyance control by the registration roller 23.

On the downstream side of the aforesaid secondary transfer roller 7A, there is provided fixing device 17 that conducts fixing process on sheet P onto which the color image has been transferred. The fixing device 17 has an unillustrated fixing roller, a pressure roller, a thermal heater (IH), and fixing cleaning section 17A. In an operation of the fixing process, sheet P is caused to pass between the fixing roller heated by the thermal heater and the pressure roller, whereby, the sheet P is heated and pressed. The sheet P after the fixing is interposed between sheet ejection rollers 24 to be ejected to an ejection tray (not shown) that is outside of an apparatus. The fixing cleaning section 17A removes a toner remaining on the fixing roller and others after the preceding fixing (cleaning).

FIG. 2 is a perspective view showing a structural example of image forming section 80. The image forming section 80 shown in FIG. 2 is Composed of photoreceptor drums 1Y, 1M, 1C and 1K, intermediate transfer belt 6, LPH units for respective image forming colors 5Y, 5M, 5C and 5K and rotation transmitting mechanism 40. The LPH unit 5Y for Y color has a length identical to the total width of photoreceptor drum 1Y, and writes image data Dy for Y color equivalent to one line or several lines collectively in the main scanning direction, based on Y-IDX signals made from reference Index signals.

The main scanning direction in this case is a direction that is in parallel with a rotation axis of photoreceptor drum 1Y. The photoreceptor drum 1Y rotates in a sub-scanning direction. The aforesaid intermediate transfer belt 6 is moved in the sub-scanning direction at a constant linear speed. The sub-scanning direction is a direction perpendicular to the axis of rotation of photoreceptor drum 1Y. A rotation of the photoreceptor drum 1Y in the sub-scanning direction and a collective exposure in a unit of lines in the main scanning direction by LPH unit 5Y form an electrostatic latent image for Y color on photoreceptor drum 1Y.

Each of LPH units 5M, 5C and 5K for other colors also has the same length as in the foregoing, and operates collective writing of image data Dm for M color, image data Dc for C color, and image data Dk for BK color in the same way, based on M-IDX signals, C-IDX signals and K-IDX signals which constitute an example of reference signals for respective image forming colors. Y-IDX signals, M-IDX signals, C-IDX signals and K-IDX signals for respective image forming colors are supplied from writing control units 15Y, 15M, 15C and 15K. For each of LPH units 5Y, 5M, 5C and 5K, the one wherein an LED head has several thousand-several ten thousands. of pixel dots per one line is used, although it depends on the maximum width of a sheet handled in the printer 100.

In this example, the image forming section 80 is equipped with rotation transmitting mechanism 40, and three photoreceptor drums 1Y, 1M and 1C respectively for Y color, M color and C color are driven by common motor 30a at the prescribed rotating speed, through the rotation transmitting mechanism 40. The motor 30a constitutes an example of a driving section. Each of large-diameter gears 11Y, 11M, 11C and 11K has a diameter larger than a diameter of each of photoreceptor drums 1Y, 1M, 1C and 1K for respective image forming colors, for example, and the large-diameter gears are attached, corresponding respectively to the photoreceptor drums 1Y, 1M, 1C and 1K. Large-diameter gear 11Y is attached on photoreceptor drum 1Y. Other large-diameter gears 11M, 11C and 11K are also attached in the same way.

Idle gear 12a is engaged with large-diameter gears 11Y and 11M, while, idle gear 12b is engaged with large-diameter gears 11M and 11C. The idle gear 12a and the large-diameter gears 11Y and 11M have a prescribed gear ratio, and the idle gear 12b and the large-diameter gears 11M and 11C also have a prescribed gear ratio.

In this example, idle gear 12b engages with motor 30a through motor gear 13c. The motor 30a has motor shaft 13a on which motor gear 13c is attached. The motor gear 13c and idle gear 12a have a prescribed gear ratio.

In the rotation transmitting mechanism 40, when motor 30a rotates counterclockwise, idle gear 12b rotates clockwise based on the gear ratio 1:β, and this rotation of the idle gear 12b causes large-diameter gear 11M and large-diameter gear 11C to rotate counterclockwise at a prescribed gear ratio. The rotation of the large-diameter gear 11M causes the photoreceptor drum 1M to rotate counterclockwise. In the same way, the rotation of the large-diameter gear 11C causes photoreceptor drum 1C to rotate counterclockwise.

When the large-diameter gear 11M rotates counterclockwise, idle gear 12a rotates clockwise. When this idle gear 12a rotates clockwise, large-diameter gear 11Y rotates counterclockwise. Further when the large diameter gear 11Y rotates, the photoreceptor drum 1Y rotates counterclockwise. Owing to this, three photoreceptor drums 1Y, 1M and 1C respectively for Y color, M color and C color can be driven by one common motor 30a through the rotation transmitting mechanism 40.

In this connection, single photoreceptor drum 1K for BK color drives directly large-diameter gear 11K with motor 30b without inclusion of the idle gear, corresponding to a monochromatic high speed mode. In the rotation transmitting mechanism 40, motor 30b is provided in addition to motor 30a. The motor 30b also constitutes an example of a driving section, and it has motor shaft 13b to which motor gear 13d is attached. The motor gear 13d and the large-diameter gear 11K have a prescribed gear ratio.

In this example, on the shaft portion of large-diameter gear 11M for M color, there is attached encoder 41 that constitutes a cycle detecting device, and for example, the rotating speed of photoreceptor drum 1M for M color is detected, and drum revolution signals (hereinafter referred to as TRIG signals) are outputted. As is stated above, three photoreceptor drums 1Y, 1M and 1C respectively for Y color, M color and C color are driven by one motor 30a, and image forming section 80 that can drive directly a photoreceptor drum for GK color by single motor 30b is constituted.

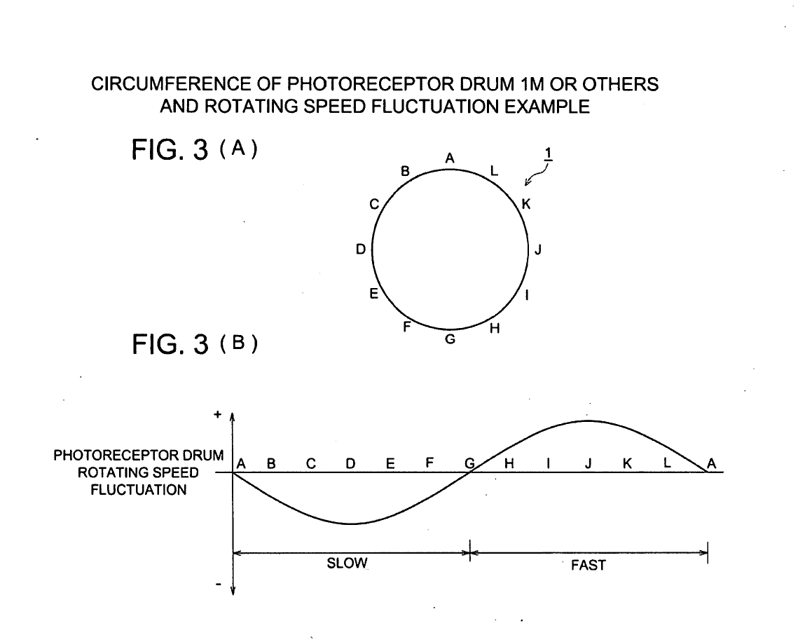

Next, unevenness of rotating speed fluctuation of photoreceptor drum 1Y will be described as follows, referring to FIGS. 3 (A), 3 (B), 4 (A) and 4 (B). Each of FIGS. 3 (A) and 3 (B) is a diagram showing a circumference of photoreceptor drum 1Y or others and an example of fluctuation of its rotating speed.

An assumption in this example is that a circumference of a drum is divided into n parts for each of photoreceptor drums 1Y, 1M, 1C and 1K respectively for Y, M, C and BK colors, and reference index signals are applied on each n-divided block, so that color images respectively for Y, M, C and BK colors are formed. A circumference of photoreceptor drum shown in FIG. 3 (A) is divided into “n” pieces, for example, an outer circumference 360° of photoreceptor drum 1Y or the like shown in FIG. 3 (A) is divided equally into 12 pieces each being 30°, and points A-L which divide into blocks are set to establish 12 blocks showing sections A→B, B→C, C→D, D→E, E→F, F→G, G→H, H→I, I→J, J→K, K→L and L→A.

Further, in the rotating speed fluctuation example of photoreceptor drum 1Y shown in FIG. 3 (B), a section of 6 blocks of A→B→C→D→E→F→G in the first half is in the state where the rotating speed of photoreceptor drum 1Y is slower because of decentering or other reasons, while, a section of 6 blocks of G→H→I→J→K→L→A in the second half is in the state where the rotating speed is faster, in contrast to the foregoing.

Each of FIG. 4 (A) and FIG. 4 (B) is an operation time chart showing a cycle correction example of reference index signals. The horizontal axis of FIG. 4 (A) represents drum positions for one circumference of photoreceptor drum 1Y, and in this example, the horizontal axis shows 6 blocks in the first half, that is, sections A→B→C→D→E→F→G. T represents the ideal elapsed time (cycle of reference index signals) obtained by converting the rotating speed for passing through one block into a time under the assumption that the rotating speed does not fluctuate.

The horizontal axis for index signals shown in FIG. 4 (B) represents time t, and it shows 6 blocks of sections A→B→C→D→E→F→G in the state where the rotating speed is slower as shown in FIG. 3 (B). In this example, point B of the section of blocks A→B is shifted to point B′ with reference to point A, point C of the section of blocks B→C is shifted to point C′ with reference to point B, point D of the section of blocks C→D is shifted to point D′ with reference to point C, point E of the section of blocks D→E is shifted to point E′ with reference to point D and point F of the section of blocks E→F is shifted to point F′ with reference to point E.

With respect to ideal cycles T for points A, B, C, D, E and F of the section shown in FIG. 4 (A), for example, the cycle is changed to cycle t1 for section A→B′, to cycle t2 for section B→C′, to cycle t3 for section C→D′, to cycle t4 for section D→E′, and to cycle t5 for section E→F′.

In this example, when rotating speed fluctuation value Δtn represents a time difference (tn−T; phase difference) between a point of the block section in the case of assumption of “no” rotational fluctuation of photoreceptor drum 1Y and a point of the same block section in the case of assumption of “existence” of rotational fluctuation, a time difference between points B-B′ is Δt1, a time difference between points C-C′ is Δt2, a time difference between points D-D′ is Δt3, a time difference between points E-E′ is Δt4 and a time difference between points F-F′ is Δt5. Rotating speed fluctuation value Δtn is composed of the time differences Δt1-Δt5.

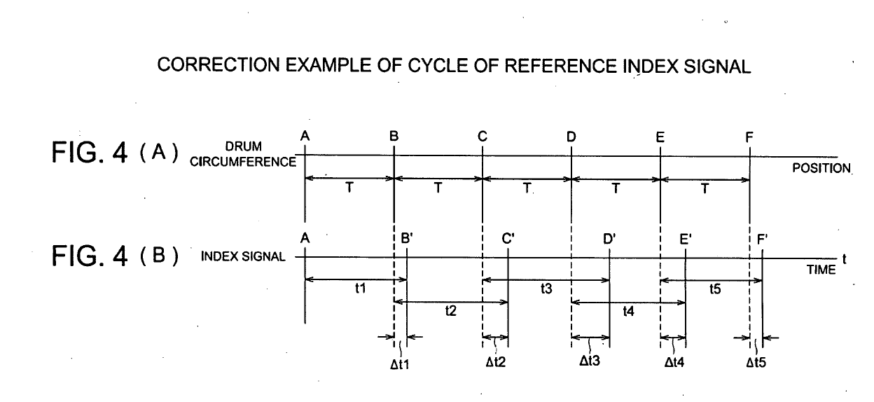

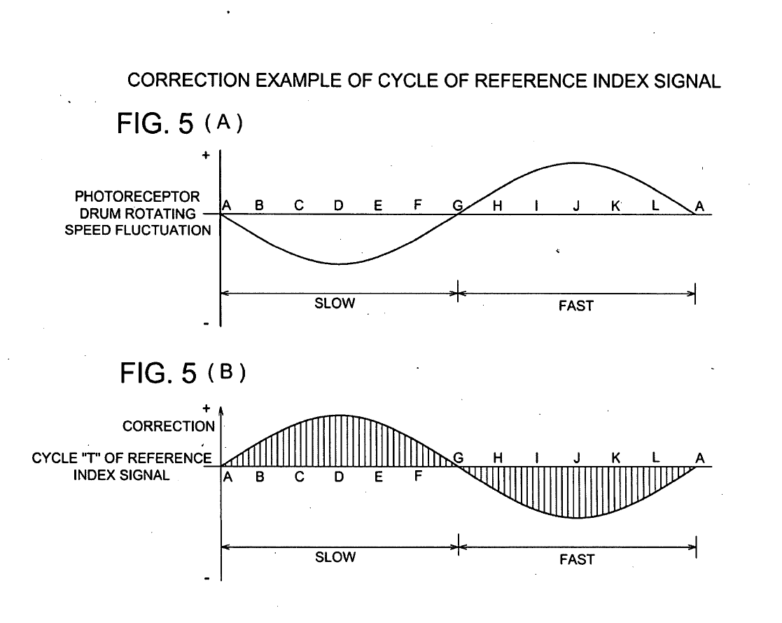

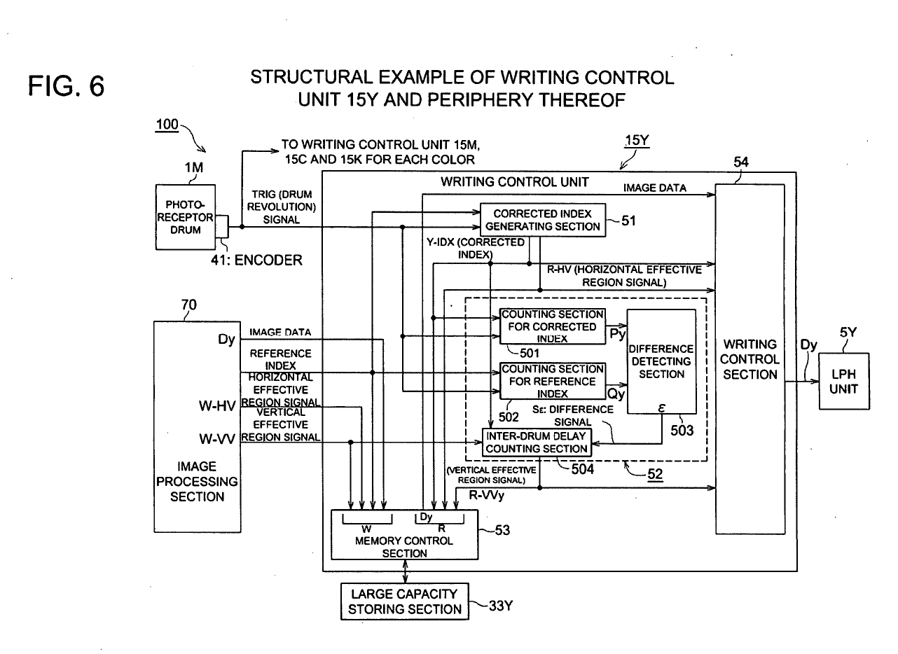

In the corrected index generating section 51 shown in FIG. 6, in this example, concerning 12 blocks of sections A→B, B→C, C→D, D→E, E→F, F→G, G→H, H→I, I→J, J→K, K→L and L→A, a difference of the passing time (expected value) at the point in each section, namely, rotating speed fluctuation value Δtn shown in FIG. 4 (B) is obtained for each block, and these rotating speed fluctuation values Δtn of the quantity equivalent to the number of blocks are stored in an unillustrated memory in corrected index generating section 51, to be applied. The rotating speed fluctuation values Δtn are stored as rotating speed fluctuation data D1.

In the corrected index generating section 51, rotating speed fluctuation data D1 (rotating speed fluctuation value Δtn) is read out of its memory, and rotating speed fluctuation value Δtn shown by rotating speed fluctuation data D1 is divided by line number L in the block to calculate a value of rotating speed line fluctuation H (D1/L=H) per one line, and it is distributed to each block. The rotating speed line fluctuation value H is, for example, a complement of “2”. Thus, complement H is added to or deducted from cycle T of reference index signals, and Y-IDX signals of cycle T+H1 are generated. The Y-IDX signals are writing reference (synchronous) signals when forming a Y color image on photoreceptor drum 1Y for Y color. Correction time Δtn−Δtn−1 is reflected on Y-IDX signals for each block.

FIG. 5 (A) and FIG. 5 (B) show diagrams showing correction example of cycle of reference index signals for canceling rotating speed unevenness of photoreceptor drum 1Y. FIG. 5 (A) is a wave form chart showing rotating speed fluctuation example of photoreceptor drum before correction. Description for examples of rotating speed fluctuation shown in FIG. 5 (A) will be omitted because they are the same as those shown in FIG. 3 (B).

In this example, in the case of examples of rotating speed fluctuation of photoreceptor drum 1Y shown in FIG. 5 (A), with respect to the section of 6 blocks on the first half of A→B→C→D→E→F→G, photoreceptor drum 1Y or the like rotates more slowly than usual because image data Dy, for example, its exposure amount is high and load is increased, therefore, reference index signals are corrected by correction time Δtn−Δtn−1 so that its cycle T may be longer, to be Y-IDX signals.

Further, with respect to the section of 6 blocks on the second half of G→H→I→J→K→L→A, an amount of exposure by image data Dy is low, load is reduced and photoreceptor drum 1Y or the like is rotated at higher speed than usual, on the contrary, therefore, reference index signals are corrected by correction time Δtn−Δtn−1, so that its cycle T may be shorter, to be Y-IDX signals.

FIG. 5 (B) is a wave form chart showing an example of cycle distribution of reference index signals after correction. According to the example of cycle distribution of reference index signals after correction shown in FIG. 5 (B), rotating speed unevenness in a form of a sine wave shown in FIG. 5 (A) is canceled by cycle distribution of reference index signals after correction in a form of a sine wave shown in FIG. 5 (B). A cycle distribution wave form of the reference index signals after correction in this example is represented by an occasion in which 100 lines are assigned in one block wherein correction time Δtn−Δtn−1 is divided into 100 pieces, and Y-IDX signals are obtained by correcting a cycle of the reference index signals by Δtn−Δtn−1/100 that is one correction time per 100 lines.

FIG. 6 is a block diagram showing a structural example of writing control unit 15Y for Y color and of its peripheral portion. In this example, there will be described an occasion wherein the reference index signals are corrected for each image forming color based on drum revolution signals (TRIG signals) of photoreceptor drum 1M (see FIG. 2) for M color among four photoreceptor drums 1Y, 1M, 1C and 1K respectively for Y color, M color, C color and BK color, and a vertical effective area signals for adjusting a position to start writing when reading image data are adjusted. It is naturally possible to employ a construction wherein drum revolution signals of either one of other photoreceptor drums 1Y, 1C and 1K are detected to correct the reference index signals for each image forming color, and a vertical effective area signals for adjusting a position to start writing are adjusted.

On the rotating shaft of photoreceptor drum 1M, there is attached encoder 41 that constitutes an example of a cycle detecting device, whereby, the rotating speed of the photoreceptor drum 1M is detected, and drum revolution signals (TRIG signals) are outputted. The TRIG signals are pulses which are generated once when the drum makes one revolution, and they are signals generated on an asynchronous basis for the reference index signals. The TRIG signals are signals which reflect rotating speed fluctuation unevenness of the photoreceptor drum 1M due to such as decentering.

Encoder 41 is connected to writing control units 15M, 15C and 15K respectively for M color, C color and BK color, in addition to writing control unit 15Y for Y color, to output TRIG signals to writing control units 15M, 15C and 15K respectively for M color, C color and BK color in addition to writing control unit 15Y for Y color. In this example, it is possible to adjust start positions of writing images (writing start positions) from the side of photoreceptor drums 1Y, 1m, 1C and 1k by only one TRIG signal, by outputting TRIG signals detected from the rotating speed of photoreceptor drum 1M for M color to writing control units 15Y, 15M, 15C and 15K respectively for Y color, M color, C color and BK color.

In this example, signals outputted from image processing section 70 to writing control unit 15Y for Y color are image data Dy and control signals such as horizontal effective area signals for writing (hereinafter referred to as W-HV signals), reference index signals and vertical effective area signals for writing (hereinafter referred to as W-VV signals). Signals outputted from image processing section 70 to writing control unit 15M for M color are image data Dm and the aforesaid control signals. Signals outputted from image processing section 70 to writing control unit 15C for C color are image data Dc and the aforesaid control signals. Signals outputted from image processing section 70 to writing control unit 15K for BK color are image data Dk and the aforesaid control signals. Each of image data Dy, Dm, Dc and Dk is constituted respectively of a bus for each image forming color, and the aforesaid control signals are supplied commonly for respective image forming colors.

Writing control unit 15Y for Y color is composed of corrected index generating section 51, timing control section 52, memory control Section 53 and writing control section 54. In this example, into writing control side (W) of memory control section 53, there are inputted control signals such as image data Dy, horizontal effective area signals for writing (hereinafter referred to as W-HV signals), reference index signals and W-VV signals for writing outputted from image processing section 70.

Corrected index generating section 51 constitutes an example of a signal generating device wherein TRIG signals detected by encoder 41 are inputted, reference index signals are corrected with prescribed amount of correction based on TRIG signals and reference signals for writing for Y color image after correction (Y-IDX signals) are generated. The corrected index generating section 51 is provided for each image forming color. The aforesaid amount of correction represents data for correcting the rotating speed fluctuation unevenness of photoreceptor drum 1M, and it is prepared in advance as correction data table, and these correction data are consulted.

To the corrected index generating section 51, there are connected timing control section 52, memory control section 53 and writing control section 54. The timing control section 52 is composed of counting section 501 for corrected index, counting section 502 for reference index, difference detecting section 503 and inter-drum delay amount counting section 504, thus, the number of pulses of Y-IDX signals made by corrected index generating section 51 is compared with the number of pulses of reference index signals for each image forming color, whereby, output timing of image data Dy for Y color is adjusted based on the results of the comparison.

TRIG signals coming from the aforesaid encoder 41 are outputted to two types of counting sections 501 and 502. The counting section 501 for corrected index constitutes an example of the first counting section, and count value Py which has been counted up to the present moment of pulse numbers of Y-IDX signals after correction generated by corrected index generating section 51 are outputted at the time of start-up of W-VV signals (vertical effective area signals) for all colors in common. The counting section 501 is provided for each image forming color.

The counting section 502 for reference index constitutes an example of the second counting section, whereby, the number of pulses of reference index signals is counted, and count value Qy is outputted. The counting section 502 is provided for each image forming color. Both counting sections 501 and 502 are made to show “0” at the time of inputting TRIG signals. These two types of counting sections 501 and 502 are always caused by TRIG signals to show “0” for each image forming color. In this example, the number of pulses of reference index signals and the number of pulses of Y-IDX signals after correction are counted based on the start-up time of TRIG signal, for each of counting sections 501 and 502.

To both of the counting sections 501 and 502, there is connected difference detecting section 503 for Y color that constitutes an example of a calculating section, and difference value ε (complement of 2) between the number of pulses of Y-IDX signals and the number of pulses of reference index signals are calculated from output values Py and Qy respectively of the counting section 501 and the counting section 502. The difference value ε is stored in an unillustrated memory in the difference detecting section 503. The difference value ε is outputted from the difference detecting section 503 to inter-drum delay amount counting section 504 as difference signal Sε. The difference detecting section 503 is provided for each image forming color, and this difference calculating operation is conducted for each image forming color, and this difference signal Se is outputted simultaneously. By doing this, it is possible to adjust the timing for reading image data Dy, Dm, Dc and DK for respective image forming colors based on the difference value ε.

Inter-drum delay amount counting section 504 is connected to the difference detecting section 503, then, a count of inter-drum delay amount (Y) is started at the start-up time of W-VV signal for writing that is common to the respective colors, and difference value ε coming from difference detecting section 503 is added to set value Xy of inter-drum delay amount (Y), and when the count value arrives at the set value Xy in which the difference value ε is taken account of, vertical effective area signals (hereinafter referred to as R-VVy signals) for adjusting writing start position on photoreceptor drum 1Y at the time of start reading image data for Y color are started up (are caused to be active).

In this example, inter-drum delay amount counting section 504 starts up R-VVy signals from a low level (hereinafter referred to as “L” level) to a high level (hereinafter referred to as “H” level). Image data Dy can be read out only for the period where R-VVy signals are at “H” level. This also applies to other image forming colors.

In this example, under the assumption of the occasion to read out image data Dy, Dm, Dc and Dk to image forming section 80 respectively from large capacity storing sections 33Y, 33M, 33C and 33K in the order of Y, M, C and BK colors, set value Xy=“4” is set on inter-drum delay amount counting section 504 for Y color, set value Xm=“6” is set on inter-drum delay amount counting section 504 for M color, set value Xy=“8” is set on inter-drum delay amount counting section 504 for C color, and set value Xm=“10” is set on inter-drum delay amount counting section 504 for BK color.

As stated above, even when image data for Y color Dy is read out from large capacity storing section 33Y to image forming section 80, set value Xy=“4” is set, and the reading time is caused to have a margin. The reason for this is to secure that the set value Xy of inter-drum delay amount [Y] in which difference signal Sε is considered never fails to be 1 or more.

The purpose of the set values Xy, Xm, Xc and Xk of inter-drum delay amount is for adjusting timing for reading image data Dy, Dm, Dc and Dk for respective image forming colors. When the output timing is adjusted in this way, it is possible to align a position (timing) of writing for the forefront of M color image and C color image on photoreceptor drums 1M and 1C of other image forming colors to a position (timing) for the forefront of Y color image on photoreceptor drum 1Y of Y color.

Memory control section 53 for Y color is connected to the aforesaid writing control section 54, image processing section 70 and to inter-drum delay amount counting section 504. To the memory control section 53, there is connected large capacity storing section 33Y that constitutes an example of the storing section. The memory control section 53 writes down image data Dy for Y color on large capacity storing section 33Y from image processing section 70, based on reference index signals, W-HV signals (horizontal effective area signals) for writing and on W-VV signals for writing (vertical effective area signals). Image data Dy are data for forming Y color image in image forming section 80. Even for image data Dm, Dc and Dk for other M color, C color and BK color, writing is conducted in the similar structure.

The memory control section 53 reads out image data Dy for Y color to writing control section 54 from large capacity storing section 33Y, based on Y-IDX signals after correction, R-HV signals for reading (horizontal effective area signals) and on R-VVy signals for reading (vertical effective area signals). Even for image data Dm, Dc and Dk for other M color, C color and BK color, reading is conducted in the similar structure.

The aforesaid inter-drum delay amount counting section 504 operates based on the reference index signals, until the moment when the memory control section 53 writes image data Dy into large capacity storing section 33Y. In the case of reading operation, operations are made based on Y-IDX signals after correction, and the inter-drum delay amount counting section 504 outputs R-VVy signals for reading image data for Y color.

In the same way, the aforesaid inter-drum delay amount counting section 504 for M color operates based on the reference index signals until the moment when the memory control section 53 writes image data Dm into large capacity storing section 33M. In the case of reading operation, operations are made based on M-IDX signals after correction, and the inter-drum delay amount counting section 504 outputs R-VVm signals for reading image data for M color to memory control section 53 for M color.

The inter-drum delay amount counting section 504 for C color operates based on the reference index signals until the moment when the memory control section 53 writes image data Dc into large capacity storing section 33C. In the case of reading operation, operations are made based on C-IDX signals after correction, and the inter-drum delay amount counting section 504 outputs R-VVc signals for reading image data for C color to memory control section 53 for C color.

The inter-drum delay amount counting section 504 for BK color operates based on the reference index signals until the moment when the memory control section 53 writes image data Dk into large capacity storing section 33K. In the case of reading operation, operations are made based on K-IDX signals after correction, and the inter-drum delay amount counting section 504 outputs R-VVk signals for reading image data for BK color to memory control section 53 for BK color.

The reason for switching between reference index signals and Y-IDX signals in processing of writing/reading for image data Dy or the like, as stated above is to adjust the reading timing for each of image data Dy, Dm, Dc and Dk with each of set values Xy, Xm, Xc and Xk for inter-drum delay amount for each image forming color.

Next, an example of operations of writing image data into a large capacity storing section, and an example of operations of reading out image data from a large capacity storing section to a photoreceptor drum, in color printer 100, will be described. As an example of operations in this color printer 100, an occasion wherein a circumference of a drum is divided into 100 parts, for example, for each of photoreceptor drums respectively for Y, M, C and BK colors, and reference index signals are applied to each 100-divided block to form images respectively in Y, M, C and BK colors is cited.

Further, TRIG signals of either one of photoreceptor drums 1Y, 1M, 1C and 1K respectively for Y, M, C and BK colors which are, in this example, pulse-shaped TRIG signals generated every one circumference of the drum obtained from encoder 41 attached on the shaft portion of photoreceptor drum 1M for M color, are received by respective writing control units 15Y, 15M, 15C and 15K. Then, there is given an example of the occasion wherein a number is given (count value) each to a pulse number of reference index signals for each of Y, M, C and BK and to a pulse number of Y-IDX, M-IDX, C-IDX and K-IDX signals after correction, and a difference of the numbers between the pulse number of reference index signals at a rise of W-VV signals for writing (vertical effective area signals) and a pulse number of Y-IDX, M-IDX, C-IDX and K-IDX signals after correction is calculated for each of Y, M, C and BK, to be reflected on a writing position adjusting amount, thus, the timing of reading image data is adjusted.

With respect to an operational example of reading image data Dy or the like, it will be described by dividing it into two occasions wherein a difference value (number difference) between a count value of the pulse number of reference index signals at the time of rise of W-VV signals for writing and a count value of the pulse number of Y-IDX, M-IDX, C-IDX and K-IDX signals after correction is zero (hereinafter referred to as reading operation example I) as one occasion, and wherein these count values are different as another occasion (hereinafter referred to as reading operation example II).

### [Example of Operation of Writing Image Data]

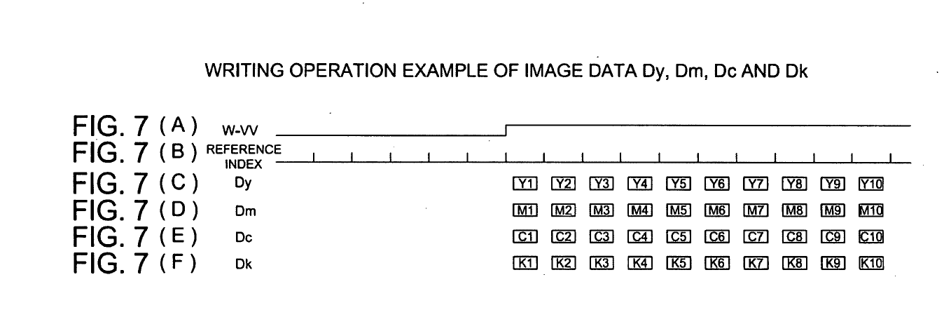

FIGS. 7 (A)-7 (F) are time charts showing examples of operations to write image data Dy, Dm, Dc and Dk to a large capacity storing sections. In the case of color printer 100, on the writing control side (w) of memory control section 53 of writing control unit 15Y, for example, there are inputted image data Dy outputted from image processing section 70, W-HV signals for writing (horizontal effective area signals), reference index signals and W-VV signals for writing.

In this example, image data Dy, Dm, Dc and Dk are written respectively in large capacity storing sections 33Y, 33M, 33C and 33K in parallel, during the period when W-VV signals for writing shown in FIG. 7 (A) are at high level (hereinafter referred to as “H” level). For example, image data Dy=Y1, Y2, Y3, Y4, Y5, Y6, Y7, Y8, Y9 and Y10 shown in Fig. (C) are synchronized with reference index signals shown in FIG. 7 (B) to be written in large capacity storing section 33Y by writing control unit 15Y.

In the same way, image data Dm=M1, M2, M3, M4, M5, M6, M7, M8, M9 and M10 shown in FIG. 7 (D) are synchronized with reference index signals to be written from writing control unit 15M to large capacity storing section 33M. Image data Dc=C1, C2, C3, C4, C5, C6, C7, C8, C9 and C10 shown in FIG. 7 (E) are synchronized with reference index signals to be written from writing control unit 15C to large capacity storing section 33C. Image data Dk=K1, K2, K3, K4, K5, K6, K7, KB, K9 and K10 shown in FIG. 7 (F) are synchronized with reference index signals to be written from writing control unit 15K to large capacity storing section 33K.

Image data Dy are regulated by W-HV signals shown in FIG. 6, and are stored in large capacity storing section 33Y for each block and for each line unit of photoreceptor drum 1Y. Even for writing control units 15M, 15C and 15K for other M, C and BK colors, image data are stored in large capacity storing sections 33Y, 33C and 33K in the same way.

### [Image Data Reading Operation Example I]

Each of FIGS. 8 (A)-8 (P) is a time chart showing image data reading operation example I in color printer 100. In this example, inter-drum delay amount [Y]=“4” is set as set value Xy on inter-drum delay amount counting section 504 for Y color, and inter-drum delay amount [M]=“6” is set as set value Xm on inter-drum delay amount counting section 504 for M color. The reason for this is to shift the timing of writing (giving exposure with) image data Dy and Dm respectively on photoreceptor drums 1Y and 1M by setting an amount equivalent to a distance from primary transfer point P1 for Y color image to primary transfer point P2 for adjoining M color image (P2−P1), as inter-drum delay amount [Y]=“4” and as inter-drum delay amount [M]=“6”. The same setting is made also for other image forming colors. The operation example I is an occasion wherein a cycle of reference index signals is the same as a cycle of Y-IDX signals after correction, that is, the difference value ε is zero.

TRIG signals shown in FIG. 8 (A) are pulses generated once while the drum makes one revolution (rotation), and they are generated asynchronously with reference index signals. In this example, the TRIG signals are obtained from encoder 41 attached on rotating shaft of photoreceptor drum 1M, and they are drum revolution signals obtained by detecting the rotating speed of the photoreceptor drum 1M. The TRIG signals are those reflecting rotating speed fluctuation unevenness caused by decentering of photoreceptor drum 1M, and they are outputted from encoder 41 to writing control units 15M, 15C and 15K respectively for M color, C color and BK color.

W-VV signals for writing (vertical effective area signals) which are common to respective image forming colors shown in FIG. 8 (B) represent an occasion wherein they have risen at the moment when counting section 502 for reference index has counted count value Qy=“4” shown in FIG. 8 (D). The counting section 502 has started counting of pulse numbers of reference index signals from the moment when the TRIG signals rose. In this case, in timing control section 52, the counting section 502 to which reference index signals are inputted shown in FIG. 8 (C) counts the number of pulses of the reference index signals, and outputs count value Qy to difference detecting section 503.

The W-VV signals for writing are outputted from image forming section 70 to writing control unit 15Y for Y color, and to the writing sides of large capacity storing sections 33Y, 33M, 33C and 33K together with image data Dy, W-HV signals for writing (horizontal effective area signals) and with reference index signals shown in FIG. 8 (C). The same thing is applied also to each of writing control units 15M, 15C and 15K for other colors M, C and BK.

Y-IDX signals shown in FIG. 8 (E) are reference signals for writing for Y color image after correction which are made by corrected index generating section 51 for Y color into which TRIG signals shown in FIG. 8 (A) are inputted, by correcting reference index signals with a prescribed amount of correction. For an amount of correction, an unillustrated correction data table for Y color is consulted. The present example is an occasion where an amount of correction is zero, and a cycle of Y-IDX signals and a cycle of reference index signals are the same. Y-IDX signals are outputted from corrected index generating section 51 to counting section 501 for corrected index, inter-drum delay amount counting section 504 and to writing control section 54.

Count value Py shown in FIG. 8 (F) is outputted from counting section 501 that counted a pulse number of Y-IDX signals after correction shown in FIG. 8 (E) to difference detecting section 503 when W-VV signal rises. Counts of both counting sections 501 and 502 are returned to zero when TRIG signals are inputted. Each of these two type counting sections 501 and 502 is always returned to zero for each image forming color by the TRIG signals. Both counting sections 501 and 502 count the pulse number of reference index signals and the pulse number of Y-IDX signals after correction, based on the rising time of TRIG signals.

Difference detecting section 503 inputs count values Py and Qy respectively of counting section 501 and counting section 502, and calculates reference index number (count value Qy)−corrected index number (count value Py). Difference values is stored in an unillustrated memory in difference detecting section 503 for Y color. The difference values is outputted from the difference detecting section 503 to inter-drum delay amount counting section 504 as difference signal Sε. This operation example I is in an occasion of difference value ε=0. In this case, a cycle of reference index signals is the same as that of Y-IDX signals. Processing of calculation of difference value ε by comparing a pulse number of Y-IDX signals with a pulse number of reference signals for image writing is carried out by the difference detecting section 503 for each image forming color.

Set value Xy shown in FIG. 8 (G) represents an occasion of inter-drum delay amount [Y]=“4”. Inter-drum delay amount counting section 504 starts counting of inter-drum delay amount [Y] from the starting time of W=VV signals for writing which are common to respective image forming colors, then, it adds difference value ε from difference detecting section 503 to set value Xy of inter-drum delay amount [Y], and raises (activates) R-VVy signals (vertical effective area signals) for reading Y color image shown in FIG. 8 (H) when the count value becomes set value Xy of inter-drum delay amount [Y] in which the difference value ε is taken account of, to output R-VVy signals to memory control section 53.

R-VVy signals serve as reading control signals, and when “4” is counted for inter-drum delay amount [Y] shown in FIG. 8 (G), they are raised from level “L” to level “H”. R-VVy signals are signals on the reading side of memory control section 53. As stated above, inter-drum delay amount counting section 504 conducts counting up to set value Xy of inter-drum delay amount [Y] wherein difference value ε between count value Qy of pulse number of reference index signals and count value Py of pulse number of Y-IDX signals after correction is considered. Owing to this, processing to read out image data Dy from large capacity storing section 33Y can be started.

Image data Dy for Y color shown in FIG. 8 (I) are read out of large capacity storing section 33Y based on R-VVy signals for reading Y color image data shown in FIG. 8 (H). In this example, memory control section 53 reads out image data Dy from large capacity storing section 33Y to writing control section 54 based on R-VVy signals. The writing control section 54 writes image data Dy into LPH unit 5Y based on Y-IDX signals.

Image data Dy written on photoreceptor drum 1Y in FIG. 8 (I) are transferred primarily onto intermediate transfer belt 6 from photoreceptor drum 1Y shown in FIG. 8 (J). In this example, primary transfer roller 7Y operates to conduct primary transfer in the order of image data Dy=y1, Y2, Y3, Y5 . . . , at primary transfer point P1 shown in FIG. 1.

M-IDX signals shown in FIG. 8 (k) are reference signals for writing M color image after correction which were made by corrected index generating section 51 for M color into which TRIG signals shown in FIG. 8 (A) are inputted, by correcting reference index signals with prescribed amount of correction. For the amount of correction, an unillustrated correction data table for M color is used for a reference. In the present example, a cycle of M-IDX signals is the same as that of reference index signals, and the amount of correction is zero. The M-IDX signals are outputted to counting section 501 for corrected index from corrected index generating section 51.

When W-VV signals for M color rises, count value Pm shown in FIG. 8 (L) is outputted to difference detecting section 503 from counting section 501 that counted the pulse number of M-IDX signals after correction shown in FIG. 8 (K). Both of counting sections 501 and 502 are arranged to be set to zero when TRIG signals are inputted. These two types of counting sections 501 and 502 are always set to zero with TRIG signals for each of image forming colors. Either of counting sections 501 and 502 counts the pulse number of reference index signals and the pulse number of M-IDX signals after correction, on the basis of rising time of TRIG signals.

Difference detecting section 503 inputs count value Pm of counting section 501 and count value Qm of counting section 502, and calculates reference index number (count value Qm)−corrected index number (count-value Pm). Difference value ε is stored and preserved in an unillustrated memory in difference detecting section 503 for M color. The difference value ε is outputted to inter-drum delay amount counting section 504 from the difference detecting section 503 as difference signal Sε. This operation example I is of the occasion of difference value ε=0. In this case, a cycle of reference index signals is the same as that of M-IDX signals.

Processing by difference detecting section 503 to compare the pulse number of M-IDX signals with the pulse number of reference signals for image writing and thereby to calculate difference value ε is conducted for each image forming color. The difference detecting section 503 is provided for each image forming color, then, this difference calculation operation is carried out for each image forming color, and difference signal Sε is outputted simultaneously. By doing this, it is possible to adjust primary transfer points P1, P2, P3 and P4 respectively for Y, M, C and BK colors and reading timing for image data Dy, Dm, Dc and Dk for respective image forming colors based on difference value wherein drum rotating speed fluctuation unevenness is considered.

Set value Xm shown in FIG. 8 (M) is of the occasion wherein inter-drum delay amount [M] is “6”. Inter-drum delay amount counting section 504 starts counting inter-drum delay amount [M] from the moment when W-VV signals for writing which are common to respective image forming colors rise, then, adds difference value ε from difference detecting section 503 to set value Xm of inter-drum delay amount [M], and it raises (activates) R-VVm signals (vertical effective area signals) for reading M color image data shown in FIG. 8 (N) and outputs R-VVm signals to memory control section 53 when the count value becomes set value Xm for inter-drum delay amount [M] in which difference value ε is taken account of.

R-VVm signals serve as reading control signals, and when “6” is counted for inter-drum delay amount [M] shown in FIG. 8 (M), they are raised to level “H”. R-VVm signals are signals on the reading side of memory control section 53. As stated above, inter-drum delay amount counting section 504 conducts counting up to set value Xm of inter-drum delay amount [M] wherein difference value ε between count value Qm of pulse number of reference index signals and count value Pm of pulse number of M-IDX signals after correction is considered. Owing to this, processing to read out image data Dm from large capacity storing section 33M can be started.

Image data Dm for M color shown in FIG. 8 (O) are read out of large capacity storing section 33M based on R-VVm signals for reading M color image data shown in FIG. 8 (N). In this example, memory control section 53 reads out image data Dm from large capacity storing section 33M to writing control section 54 based on R-VVm signals. The writing control section 54 writes image data Dm into LPH unit 5M based on M-IDX signals.

Image data Dm written on photoreceptor drum 1M in FIG. 8 (O) are transferred primarily onto intermediate transfer belt 6 from photoreceptor drum 1M shown in FIG. 8 (P). In this example, primary transfer roller 7M operates to conduct primary transfer onto intermediate transfer belt 6 in the order of image data Dm M1, M2, M3, M5 . . . , at primary transfer point P2 shown in FIG. 1.

In this image data reading operation example I, an operation of counting the pulse number for each of Y-IDX, M-IDX, C-IDX and K-IDX signals is conducted for each of respective image forming colors, from the rising moment of TRIG signals. Inter-drum delay amount counting section 504 starts counting the pulse number of Y-IDX signal after correction from the rising time for W-VVy signals.

In the memory control section 53 for Y color, image data Dy for Y color is written from large capacity storing section 33Y to LPH unit 5Y through writing control section 54, based on R-VVy signals adjusted in terms of output timing by inter-drum delay amount counting section 504.

Even in the writing control unit for M color, memory control section 53 for M color is caused to write image data Dm for M color to LPH unit 5M through writing control section 54 from large capacity storing section 33M, based on R-VVm signals adjusted in terms of output timing by inter-drum delay amount counting section 504.

Even in the writing control unit for C color, memory control section 53 for C color is caused to write image data Dc for C color to LPH unit 5C through writing control section 54 from large capacity storing section 33C, based on R-VVc signals adjusted in terms of output timing by inter-drum delay amount counting section 504.

Even in the writing control unit for BK color, memory control section 53 for BK color is caused to write image data Dk for BK color to LPH unit 5K through writing control section 54 from large capacity storing section 33K, based on R-VVk signals adjusted in terms of output timing by inter-drum delay amount counting section 504. Owing to this, it is possible to align the forefront writing timing for each of M color image, C color image and BK color image with respect to the photoreceptor drum 1Y for Y color.

In addition, for the rotating speed fluctuation (unevenness) of photoreceptor drum 1m or the like, a cycle of reference index signals is corrected by referring to a correction data table, and Y-IDX, M-IDX, C-IDX and K-IDX signals cancelling rotating speed fluctuation unevenness are generated. Owing to this, it is possible to control intervals for exposure for LPH units 5Y, 5M, 5CF and 5K, and it has become possible to form images at regular intervals in the sub-scanning direction by primary transfer rollers 7Y, 7M, 7C and 7K.

### [Image Data Reading Operation Example II]

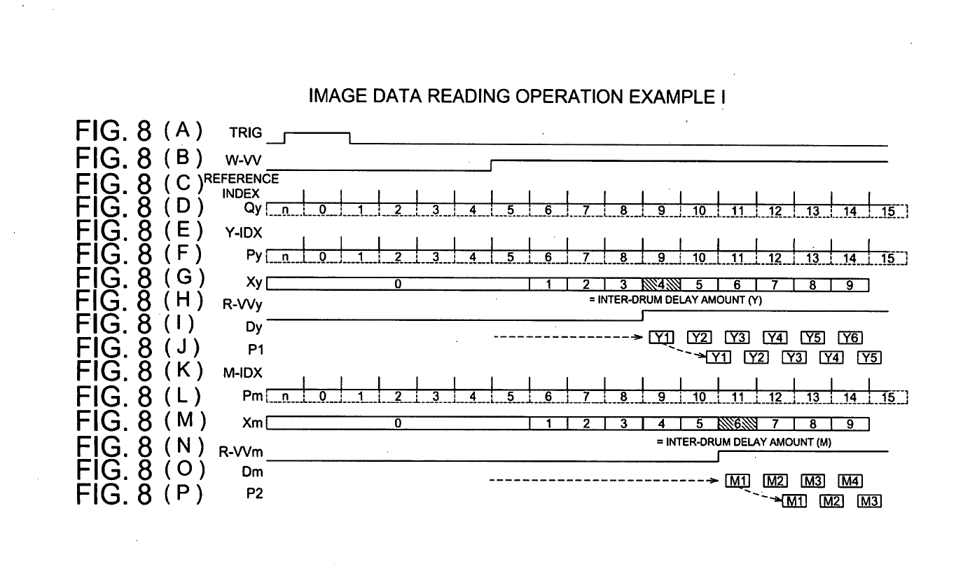

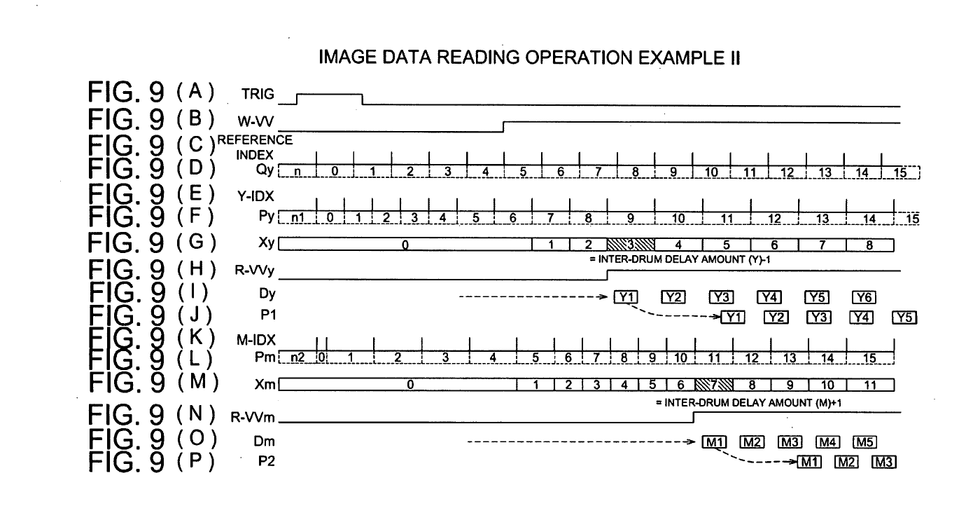

FIGS. 9 (A)-9 (P) are time charts showing image data reading operation example II in color printer 100. Also in this example, inter-drum delay amount [Y]=“4” is set on inter-drum delay amount counting section 504 for Y color as set value Xy, and inter-drum delay amount [M]=“6” is set on inter-drum delay amount counting section 504 for M color as set value Xm. The operation example II is an occasion wherein a cycle of reference index signals is different from that of Y-IDX signals after correction, namely, an occasion where difference value ε is not zero.

TRIG signals shown in FIG. 9 (A) are pulses which are generated once when the drum makes one revolution (rotation), in the same way as in operation example I, and they are generated on an asynchronous basis for the reference index signals. Also in this example, the TRIG signals are outputted from encoder 41 to writing control units 15M, 15C and 15K respectively for M color, C color and BK color.

W-VV signals for writing which are common to respective image forming colors shown in FIG. 9 (B) (vertical effective area signals) represent an occasion where counting section 502 for reference index rises when count value Qy=“4” shown in FIG. 9 (D) is counted. The counting section 502 starts counting the pulse number of reference index signals from the moment when TRIG signals rise. The counting section 502 inputs reference index signals shown in FIG. 9 (C), and counts pulse number of the signals to output count value Qy to difference detecting section 503.

W-VV signals for writing are outputted from image processing section 70 to writing control unit 15Y for Y color and outputted to the writing side on each of large capacity storing sections 33Y, 33M, 33C and 33K, together with image data Dy, W-HV signals for writing (horizontal effective area signals) and reference index signals shown in FIG. 9 (C). The similar way is also applied to writing control units 15M, 15C and 15K respectively for other M, C and BK colors.

Y-IDX signals shown in FIG. 9 (E) are reference signals for writing Y color image after correction which were made by corrected index generating section 51 for Y color into which TRIG signals shown in FIG. 9 (A) are inputted, by correcting the reference index signals with prescribed amount of correction. For the amount of correction, an unillustrated correction data table for Y color is used for a reference. The Y-IDX signals are outputted to counting section 501 for corrected index, inter-drum delay amount counting section 504 and writing control section 54 from corrected index generating section 51.

When W-VV signals for Y color rise, count value Py shown in FIG. 9 (F) are outputted from counting section 501 that has counted the pulse number of Y-IDX signals after correction shown in FIG. 9 (E) to difference detecting section 503. In the present example, a cycle of Y-IDX signals is different from that of reference index signals, and the cycle of Y-IDX signals is shorter in the early stage when counting section 501 outputs count values Py=0, 1, 2, 3 and 4, then, the cycle of Y-IDX signals becomes nearly the same as a cycle of reference index signals in the intermediate stage when count values Py=5, 6, 7 and 8 are outputted, and it is longer than a cycle of reference index signals in the latter stage when count values Py=9, 10, 11, 12, 13 and 14 are outputted.

Both of counting sections 501 and 502 are arranged to be set to zero when TRIG signals are inputted, in the same way as in operation example I. These two types of counting sections 501 and 502 are always set to zero with TRIG signals, for each image forming color, and counting section 501 is caused to count the pulse number of Y-IDX signals, while, counting section 502 is also caused to count the pulse number of reference index signals.

Difference detecting section 503 inputs count value Pm of counting section 501 and count value Qm of counting section 502. In the present example, the counting section 501 outputs count value Py=“5” to the difference detecting section 503 when W-VVy signals rise. The counting section 502 outputs count value Qy=“5” to the difference detecting section 503. The difference detecting section 503 calculates “reference index number (count value Qy)−corrected index number (count value Py)”.

Difference value ε=“−1” is stored and preserved in an unillustrated memory in difference detecting section 503 for Y color. The difference value ε=“−1” is outputted to inter-drum delay amount counting section 504 from the difference detecting section 503 as difference signal Se. This operation example II is of the occasion of difference value ε=“−1”. In this case, a cycle of reference index signals is different from that of Y-IDX signals. Processing of comparing the pulse number of Y-IDX signals with the pulse number of reference signals for image writing and of calculating the difference value ε by the difference detecting section 503 is conducted for each image forming color as the same way as in the operation example I.

Set value Xy shown in FIG. 9 (G) is amended to inter-drum delay amount [Y]−1=“3”. Inter-drum delay amount counting section 504 starts counting inter-drum delay amount [Y] from the moment when W-VV signals for writing which are common to image forming colors rise. When difference value C “−1” from difference detecting section 503 is added to set value Xy of inter-drum delay amount [Y], and when the count value becomes set value Xy=“3” of inter-drum delay amount [Y] in which the difference value ε is taken account of, R-VVy signals for reading of Y color image data shown in FIG. 9 (H) (vertical effective area signals) are raised (activated), and R-VVy signals are outputted to memory control section 53.

R-VVy signals serve as reading control signals, and when inter-drum delay amount [Y]−1=“3” shown in FIG. 9 (G) is counted, they are raised to level “H”. R-VVy signals are signals on the reading side of memory control section 53. As stated above, inter-drum delay amount counting section 504 conducts counting up to set value Xy=“3” after amendment of inter-drum delay amount [Y]−1 wherein difference value ε=“−1” between count value Qy of pulse number of reference index signals and count value Py of pulse number of Y-IDX signals after correction is considered. Owing to this, processing to read out image data Dy from large capacity storing section 33Y can be started.

Image data Dy for Y color shown in FIG. 9 (I) are read out from large capacity storing section 33Y based on R-VVy signals for Y color image data reading shown in FIG. 9 (H). In the present example, memory control section 53 reads out image data Dy from large capacity storing section 33Y to writing control section 54, based on R-VVy signals. The writing control section 54 is caused to write image data Dy on LPH unit 5Y based on Y-IDX signals.

Image data Dy written on photoreceptor drum 1Y in FIG. 9 (I) are transferred primarily onto intermediate transfer belt 6 from photoreceptor drum 1Y shown in FIG. 9 (J). On the primary transfer point P1 in the present example, primary transfer roller 7Y operates to conduct primary transfer onto intermediate transfer belt 6 in the order of image data Dy=Y1, Y2, Y3, Y4, Y5, . . . .

M-IDX signals shown in FIG. 9 (K) are reference signals for writing M color image after correction which were made by corrected index generating section 51 for M color into which TRIG signals shown in FIG. 9 (A) are inputted, by correcting reference index signals with prescribed amount of correction. For the amount of correction, an unillustrated correction data table for M color is used for a reference. The M-IDX signals are outputted to counting section 501 for corrected index from corrected index generating section 51.

When W-VV signals for M color rise, count value Pm shown in FIG. 9 (L) is outputted to difference detecting section 503 from counting section 501 that has counted the pulse number of M-IDX signals after correction shown in FIG. 9 (K). In the present example, a cycle of M-IDX signals is different from that of reference index signals, and it is longer in the early stage when counting section 501 outputs count values Pm=0, 1, 2, 3 and 4, then, the cycle becomes nearly the same as a cycle of reference index signals in the first intermediate stage when count value Pm=5 is outputted, and it is shorter than a cycle of reference index signals in the second intermediate stage when count values Pm=6, 7, 8, 9 and 10 are outputted. In the latter stage when count values Pm=11, 12, 13, 14 and 15 are outputted, the cycle of M-IDX signals is nearly the same as that of reference index signals.

Both of counting sections 501 and 502 are arranged to be set to zero when TRIG signals are inputted. These two types of counting sections 501 and 502 are always set to zero for each of image forming colors with TRIG signals, and counting section 501 is caused to count the pulse number of M-IDX signals, while, counting section 502 is caused to count the pulse number of reference index signals. Difference values is stored and preserved in an unillustrated memory in difference detecting section 503 for M color. The difference detecting section 503 is provided for each image forming color, then, this difference calculation operation is carried out for each image forming color, and difference signal Sε is outputted simultaneously.

The difference detecting section 503 inputs count value Pm and count value Qm respectively of counting section 501 and counting section 502. In the present example, when W-VVm signals rise, counting section 501 outputs count value Pm=“5” to the difference detecting section 503. Counting section 502 outputs count value Qm “4” to the difference detecting section 503. The difference detecting section 503 calculates reference index number (count value Qm)−corrected index number (count value Pm).

Difference value ε=“+1” is stored and preserved in an unillustrated memory in the difference detecting section 503 for M color. The difference value ε=“+1” is outputted from the difference detecting section 503 to inter-drum delay amount counting section 504 as difference signal Sε. This operation example II is an occasion of difference value ε=“+1”. In this case, a cycle of reference index signal is different from that of M-IDX signal. Processing of calculating difference value ε by comparing a pulse number of M-IDX signals with a pulse number of reference signals for image writing by the difference detecting section 503 is conducted for each of image forming colors, in the same way in operation example I.

Set value Xm shown in FIG. 9 (M) is amended to inter-drum delay amount [M]+1=“7”. The inter-drum delay amount counting section 504 starts counting inter-drum delay amount [M] from the moment when W-VV signals for writing, which are common to respective image forming colors rise. Difference value ε “+1” coming from the difference detecting section 503 is added to set value Xm of inter-drum delay amount [M], and when the count value becomes set value Xm=“7” of inter-drum delay amount [M] to which the difference value ε is added, R-VV signals for reading of image data for M color shown in FIG. 9 (H) (vertical effective area signals) are raised (activated), and R-VVm signals are outputted to memory control section 53.

The R-VVm signals serve as reading control signals, and when inter-drum delay amount [M]+1=“7” shown in FIG. 9 (M) is counted, they are raised from level “L” to level “H”. R-VVm signals are signals on the reading side of memory control section 53. As stated above, inter-drum delay amount counting section 504 conducts counting up to set value Xm “7” after amendment of inter-drum delay amount [M]+1 wherein difference value ε=“+1” between count value Qm of pulse number of reference index signals and count value Pm of pulse number of M-IDX signals after correction is considered. Owing to this, processing to read out image data Dm from large capacity storing section 33M can be started.

Image data Dm for M color shown in FIG. 9 (O) are read out of large capacity storing section 33M based on R-VVm signals for reading M color image data shown in FIG. 9 (N). In this example, memory control section 53 reads out image data Dm from large capacity storing section 33M to writing control section 54 based on R-VVm signals. The writing control section 54 writes image data Dm into LPH unit 5M based on M-IDX signals.

Image data Dm written on photoreceptor drum 1M in FIG. 9 (O) are transferred primarily onto intermediate transfer belt 6 from photoreceptor drum 1M shown in FIG. 9 (P). In this example, primary transfer roller 7M operates to conduct primary transfer in the order of image data Dm=M1, M2, M3, M4, M5 . . . , at primary transfer point P2 shown in FIG. 1.

In operation example II for reading image data mentioned above, memory control section 53 for Y color is caused to write image data Dy for Y color to LPH unit 5Y from large capacity storing section 33Y through writing control section 54, based on R-VVy signals adjusted by inter-drum delay amount counting section 504 in terms of output timing.

Memory control section 53 for M color is caused to write image data Dm for M color to LPH unit 5M through writing control section 54 from large capacity storing section 33M, based on R-VVm signals adjusted in terms of output timing by inter-drum delay amount counting section 504.

Even in the writing control unit for C color, memory control section 53 for C color is caused to write image data Dc for C color to LPH unit 5C through writing control section 54 from large capacity storing section 33C, based on R-VVc signals adjusted in terms of output timing by inter-drum delay amount counting section 504.

Even in the writing control unit for BK color, memory control section 53 for BK color is caused to write image data Dk for BK color to LPH unit 5K through writing control section 54 from large capacity storing section 33K, based on R-VVk signals adjusted in terms of output timing by inter-drum delay amount counting section 504.

In the color printer 100 relating to the embodiment mentioned above, when controlling image writing for each block resulting from dividing photoreceptor drum for each image forming color based on reference index signals, image data Dy, Dm, Dc and Dk are stored in corresponding respective large capacity storing sections 33Y, 33M, 33C and 33K, and the timing of start reading image data Dy is adjusted while storing image data Dy in large capacity storing section 33Y. In the timing control section 52 for Y color described earlier, the pulse number of Y-IDX signals is compared with the pulse number of reference signals for image writing for each image forming color, and output timing of image data for Y color of respective image forming colors is adjusted based the results of the comparison. For reading of image data Dm, Dc and Dk respectively for other M, C and BK colors, the timing to start is adjusted in the same way.

Therefore, it is possible to adjust (to make it agree with) the writing start positions (timing) of the forefront for other M, C and BK image forming colors to the writing start position (timing) of the forefront for image in Y image forming color of photoreceptor drum 1Y for Y image forming color, based on TRIG signals of one revolution of any one photoreceptor drum such as for 1M or the like among photoreceptor drums 1Y, 1M, 1C and 1K respectively for image forming colors of Y, M, C and K.

In addition, for rotating speed fluctuation (unevenness) of photoreceptor drum 1M or the like, a cycle of reference index signals is corrected by referring to a correction data table, and Y, M, C and K-IDX signals which eliminate the rotating speed fluctuation unevenness are generated. Owing to this, intervals of exposures for LPH units 5Y, 5M, 5C and 5K can be controlled, which makes it possible to form images at regular intervals in the sub-scanning direction with primary transfer rollers 7Y, 7M, 7C and 7K. Therefore, it has become possible to eliminate shade unevenness of color images and image shift for each image forming color even when the phases of rotating speed fluctuation unevenness of photoreceptor drums 1Y, 1M, 1C and 1K are different from each other.

In the image forming apparatus and the image forming method relating to an embodiment of the invention, when a color image based on image data of each image forming color is formed, a control device is provided, and this control device is caused to compare, for each image forming color, a pulse number of reference signals after correction with a pulse number of reference signals for image writing, and to adjust output timing of image data for each image forming color based on the results of the comparison.

Owing to this constitution, it is possible to adjust the writing start position (timing) of the forefront of each color image on a photoreceptor drum for each image forming color, based on a drum revolution signals for one revolution of any one photoreceptor drum among photoreceptor drums of respective image forming colors. In addition, even when a phase is different for each image forming color, concerning fluctuation unevenness of low frequency generated on a rotating speed of a photoreceptor drum, it is possible to eliminate shade unevenness of color images and image shift.

In the image forming apparatus relating to another embodiment of the invention, a difference value obtained through calculation by a control device for each image forming color between a pulse number of reference signals after correction and a pulse number of reference signals for image writing is added to a set value of inter-drum delay amount set in advance for each image forming color, and thereby, control signals for reading of image data of each image forming color are corrected. Therefore, it is possible to adjust writing start timing of the forefront for each color image for the photoreceptor drum for respective image forming colors.

In the image forming apparatus relating to further another embodiment of the invention, the control device reads out image data from a storing device to an image forming device for each image forming color, based on reading control signals after correction, whereby, it is possible to adjust the writing start timing of the forefront of each color image for a photoreceptor drum for each image forming color.

In the image forming apparatus relating to still further another embodiment of the invention, the calculating section calculates a difference value between both pulse numbers from output values of the first counting section that counts the pulse number of reference signals after correction for each image forming color and of the second counting section that counts the pulse number of reference signals for image writing, thus, it is possible to adjust the image data reading start timing based on the aforesaid difference value.

In the image forming apparatus relating to still further another embodiment of the invention, reference signals for image writing are applied for each block representing a n-divided portion of one circumference of photoreceptor drum for each image forming color, and an image forming device forms an each color image, thus, it becomes possible to eliminate shade unevenness of color images and image shift on each block, even when a phase is different for each image forming color, concerning fluctuation unevenness of low frequency generated on a rotating speed of a photoreceptor drum.

The present invention can be applied extremely favorably to a tandem type color printer and a color copying machine each of which is equipped with a photoreceptor drum that is driven to rotate at a prescribed speed and forms a color image, and a multifunctional machine which is equipped with functions of the color printer and the color copying machine.

What is claimed is:

1. An image forming apparatus comprising:
a plurality of photoreceptor drums;
an image forming section which forms an image by writing the image based on image data of each image forming color on each of the plurality of photoreceptor drums;
a cycle detecting section which detects a drum revolution signal generated by every revolution of one of the plurality of photoreceptor drums;
a signal generating section which corrects a reference signal for image writing based on the drum revolution signal detected by the cycle detecting section and thereby generates, for each image forming color, a reference signal after correction for image writing; and
a control section which compares, for each image forming color, a pulse number of the reference signal after correction for image writing with a pulse number of the reference signal for image writing, the reference signal after correction having been generated by the signal generating section, and which adjusts output timing of the image data of each image forming color based on a result of the comparison.

2. The image forming apparatus of claim 1,
wherein the control section calculates, for the each image forming color, a difference value of the pulse number of the reference signal after correction for image writing and the pulse number of the reference signal for image writing, the reference signal after correction having been generated by the signal generating section, and adds the calculated difference value to a set value of inter-drum delay amount set in advance for the each image forming color to generate a reading control signal for image data of the each image forming color.

3. The image forming apparatus of claim 2, further comprising:
a storing section which stores image data for forming a color image in the image forming section,
wherein the control section reads out the image data of each image forming color from the storing section to the image forming section based on the reading control signal.

4. The image forming apparatus of claim 1,
wherein the control section comprises:
a first counting section which counts, for each image forming color, the pulse number of the reference signal after correction for image writing, which has been generated by the signal generating section;
a second counting section which counts the pulse number of the reference signal for image writing; and
a calculating section which calculates, for each image forming color, a difference value of a count value of the first counting section and a count value of the second counting section.

5. The image forming apparatus of claim 1,
wherein the image forming section forms each color image by applying the reference signal for image writing to each block made by dividing a circumference of each of the plurality of photoreceptor drums for the each image forming color into “n” blocks.

6. An image forming method for forming an image by writing the image based on image data of each image forming color on a photoreceptor drum corresponding to a plurality of photoreceptor drums, the image forming method comprising the steps of:
detecting a drum revolution signal generated by every revolution of one of the plurality of photoreceptor drums;
generating, for each image forming color, a reference signal after correction for image writing by correcting a reference signal for image writing based on the detected drum revolution signal;
comparing, for each image forming color, a pulse number of the generated reference signal after correction for image writing with a pulse number of reference signal for image writing; and
adjusting output timing of image data of the each image forming color based on a result of the comparison.

7. The image forming method of claim 6,
wherein in the comparing step, a difference value of the pulse number of the reference signal after correction for image writing and the pulse number of the reference signal for image writing is calculated for the each image forming color, the reference signal after correction having been generated in the generating step, and the calculated difference value is added to a set value of inter-drum delay amount set in advance for the each image forming color to generate a reading control signal for image data of the each image forming color.

8. The image forming method of claim 7, further comprising a step of:
storing, in a storing section, image data for forming a color image in an image forming section,
wherein the image data of each image forming color is read out from the storing section to the image forming section based on the reading control signal in the adjusting step.

9. The image forming method of claim 6,
wherein the comparing step comprises steps of:
first counting, for each image forming color, of the pulse number of the reference signal after correction for image writing, which has been generated in the generating step;
second counting of the pulse number of the reference signal for image writing; and
calculating, for each image forming color, a difference value of a count value of the first counting step and a count value of the second counting step.

10. The image forming method of claim 6,
wherein each color image is formed by applying the reference signal for image writing to each block made by dividing a circumference of each of the plurality of photoreceptor drums for the each image forming color into “n” blocks.
